(19) United States
(12) Patent Application Publication
(10) Pub. No.: US 2003/0051895 A1
(43) Pub. Date: Mar. 20, 2003

(54) Insulating cover

(76) Inventor: Juergen Wilde, Fellbach (DE)

Correspondence Address: KENYON & KENYON, ONE BROADWAY, NEW YORK, NY, 10004, US

(21) Appl. No.: 10/212,560

(22) Filed: Aug. 5, 2002

(30) Foreign Application Priority Data
Aug. 3, 2001 (DE) 101 38 124.7

(51) Int. Cl. H02G 15/02

(52) U.S. Cl. 174/74 A

(57) ABSTRACT

An insulating cover for at least two electrical conductors includes two adjacent parallel tunnels, each arranged to receive one electrical conductor for the purpose of economical fabrication and the avoidance of insulation damage even over the long term, made by shaping at least one long, thin, flexible strip of electrically insulating material.

### CROSS-REFERENCE TO RELATED APPLICATIONS

The present application claims priority to Application No. 101 38 124.7, filed in the Federal Republic of Germany on Aug. 3, 2001, which is expressly incorporated herein in its entirety by reference thereto.

### FIELD OF THE INVENTION

The present invention relates to an insulating cover for at least two parallel-extending electrical conductors.

### BACKGROUND INFORMATION

In a hookup connection for a detector, in particular for determining the oxygen content in exhaust gases of internal combustion engines, as described in German Published Patent Application No. 195 23 911, at least two electrical connecting leads for the sensor element of the detector are guided inside a metal tube the end of which is affixed to a detector housing. For the purpose of electrically insulating the connecting leads from each other and from the metal tube, each connecting lead is surrounded by braided glass silk resistant to a temperature of about 700° C. Alternatively, a braiding of ceramic fibers enclosing the connecting lead is used, which reaches a temperature resistance of about 1200° C. At the sensor end and at the connector end of the connecting lead, the insulation is stripped from the electrical conductors, in order to produce a crimp connection to the sensor element and to the connecting plug.

### SUMMARY

The insulating cover according to the present invention provides a construction of the insulating cover out of one, two or more flat, flexible insulating strips forming a tunnel as the conductors pass through. This arrangement may allow the possibility of using a great number of different, economical electrically insulating materials which—in contrast to glass silk—are not suitable for braiding around conductors, to insulate parallel-extending conductors. The insulating cover may ensure a fixed arrangement of the parallel-extending conductors, so that the conductors are resistant to vibratory excitation and, even in long-term operation, damage to the insulation may not occur, such as is caused in the case of freely adjacent conductors sheathed in insulation by the jackets chafing against each other. Fabrication of the insulating covers is simple and economical, and the fabrication costs may be lowered further by selecting an inexpensive material. Depending on the number of conductors to be contained in the insulating cover, by using only one insulating strip with turned up longitudinal edges or two or more flat insulating strips, two or more tunnels may be formed with one conductor passing through each. The simple separation of insulating cover and conductor may make the insulating cover readily recyclable.

According to an exemplary embodiment of the present invention, each insulating strip is formed from one layer of a textile fabric. The textile fabric is shaped by sewing so that the tunnels are formed between the longitudinal seams.

In order to obtain tunnels with particularly large cross-sectional clearance, according to an exemplary embodiment of the present invention, the seams that extend in the longitudinal direction of the layers of textile fabric may be arranged, in at least one layer of textile fabric, at a lateral distance from each other that is smaller than the width dimension of the remaining sections between the seams, so that these sections bulge or arch up and allow greater cross-sectional clearance between them.

The insulating cover according to the present invention may be used in a hookup connection for a sensor such as is used to determine the oxygen content or the temperature in the exhaust gas of an internal combustion engine. A hookup connection of this type is distinguished by the fact that the conductors which are used to connect a sensor of a detector located in a detector housing with a plug extend inside of a metal tube, one end of which is affixed to the metal detector housing and the other end to a plug housing. In the plug housing, electrical connections are made to sheathed connecting cables, which have their ends secured in a connecting plug, so that an interface between the electrical conductors and the connecting cables is formed in the plug housing. The insulating cover according to the present invention is drawn into the metal tube, and receives the desired number of electrical conductors in its tunnels described above, so that the electrical conductors are electrically insulated both from each other and from the metal tube. Through the use of the insulating cover according to the present invention, it is possible to use bare solid wires or stranded wires as conductors, eliminating the stripping of insulation from the formerly used sheathed conductors to produce the crimped contacts at the sensor element and plug. Because of the flat insulating cover, it is also possible to flatten the metal tube, thus allowing extremely small bending or folding of the metal tube, making it possible to reduce the installation space which may be reserved for installation of the detector in the exhaust system of the internal combustion engine.

When solid wires are used as electrical conductors, in combination with the insulating cover according to the present invention, undulations may be formed in the composite of solid wires and insulating cover extending in the longitudinal direction of the metal tube, which may be used to equalize the length of the composite with the metal tube or to brace the composite against the interior wall of the tube.

If the hookup connection uses sheathed stranded hookup wires as electrical conductors to connect the sensor element directly to the plug contacts of the connecting plug, eliminating the interface between conductor and connecting cable described earlier, the insulating cover according to the present invention may be used here as well. The insulation may be stripped from the sections of the stranded wire extending in the area of the metal tube, since the PTFE sheathing of the stranded wires is not sufficiently heat-resistant. The stripped sections of the stranded wires are carried in the tunnels of the insulating cover being utilized, and are thus insulated from each other and from the metal tube.

### BRIEF DESCRIPTION OF THE DRAWINGS

FIG. 1 is a cross-sectional view of a longitudinal section of a detector having a hookup connection to a connecting plug.

FIG. 2 is a perspective view of a detector end of the hookup connection.

FIG. 3 is a cross-sectional view (top) and part of a top view (bottom) of an example embodiment of an insulating cover in the hookup connection illustrated in FIGS. 1 and 2.

FIG. 4 is a cross-sectional view (top) and part of a top view (bottom) of another example embodiment of an insulating cover in the hookup connection illustrated in FIGS. 1 and 2.

FIG. 5 is a cross-sectional view (top) and part of a top view (bottom) of another example embodiment of an insulating cover in the hookup connection illustrated in FIGS. 1 and 2.

FIG. 6 is a cross-sectional view (top) and part of a top view (bottom) of another example embodiment of an insulating cover in the hookup connection illustrated in FIGS. 1 and 2.

### DETAILED DESCRIPTION

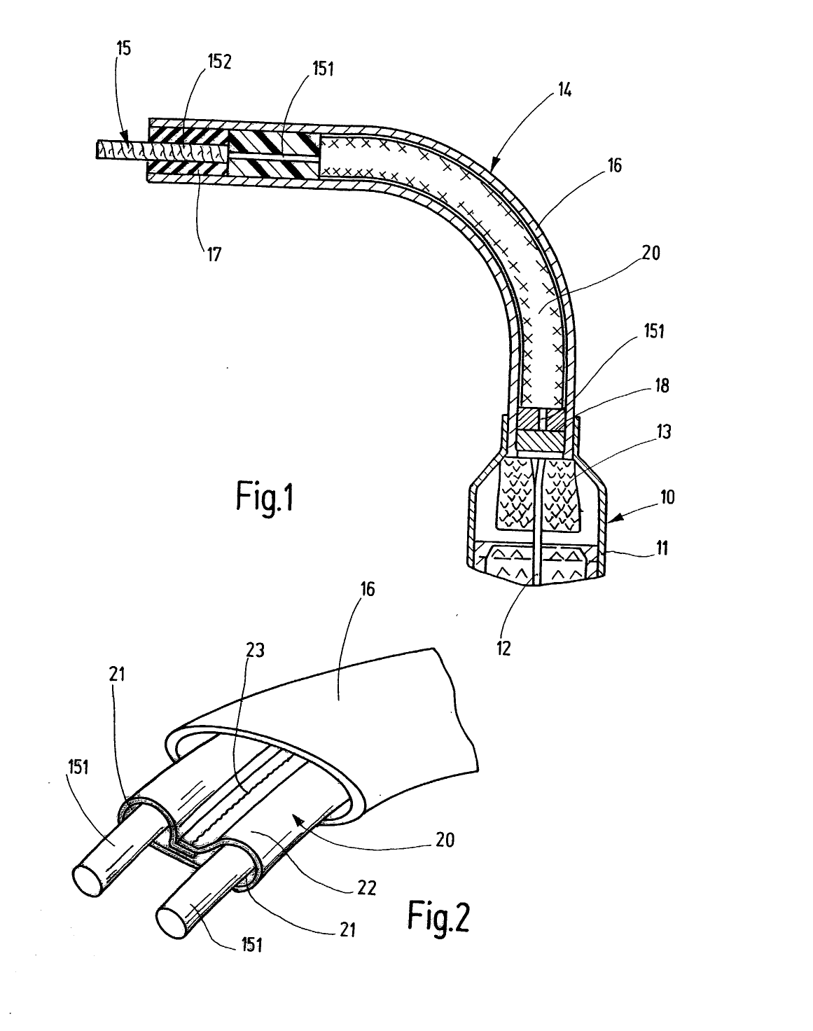

A detector 10 illustrated in FIG. 1 in a partial longitudinal section may be used, depending on the arrangement, as an exhaust gas temperature sensor for determining the exhaust gas temperature of an internal combustion engine or as a compact lambda probe for determining the oxygen content in the exhaust gas of the internal combustion engine.

The detector 10 has a sensor element 12 positioned in a detector housing 11. In FIG. 1 only the end of the sensor element inserted into an electric coupler 13 and in contact with a hookup connection 14 is illustrated. Hook-up connection 14 produces an electrical connection of detector 10 with a connecting plug. In the exemplary embodiment illustrated in FIGS. 1 and 2 for a detector 10 in the form of an exhaust gas temperature sensor, hookup connection 14 has two stranded wires 15 producing an electrical connection between electric coupler 13 in detector housing 11 and a connecting plug, and a metal tube 16 which is fixed at one end in detector housing 11 and receives the section of stranded wires 15 close to the detector. Each flexible stranded wire 15 includes a conductor 151 having a plurality of thin individual wires of a temperature-resistant material of low specific resistance little dependent on temperature, and of an insulating jacket 152 surrounding conductor 151, made of plastic, for example PTFE. Stranded wires 15 are inserted into metal tube 16 at a free end, insulating jacket 152 being held in a sealing grommet 17 that is secured in metal tube 16 in the insertion area of metal tube 16. In the section of stranded wire that extends between sealing grommet 17 and electrical coupler 13 in detector housing 11, insulating jacket 152 is removed from stranded wires 15, so that only bare conductors 151 extend in the hot zone of the internal combustion engine. At the end of metal tube 16 on the detector housing side, a limit stop 18 is positioned in metal tube 16, through which conductors 151 pass. After conductors 151 pass through, the ends of conductors 151 make contact with electrical coupler 13 in detector housing 11.

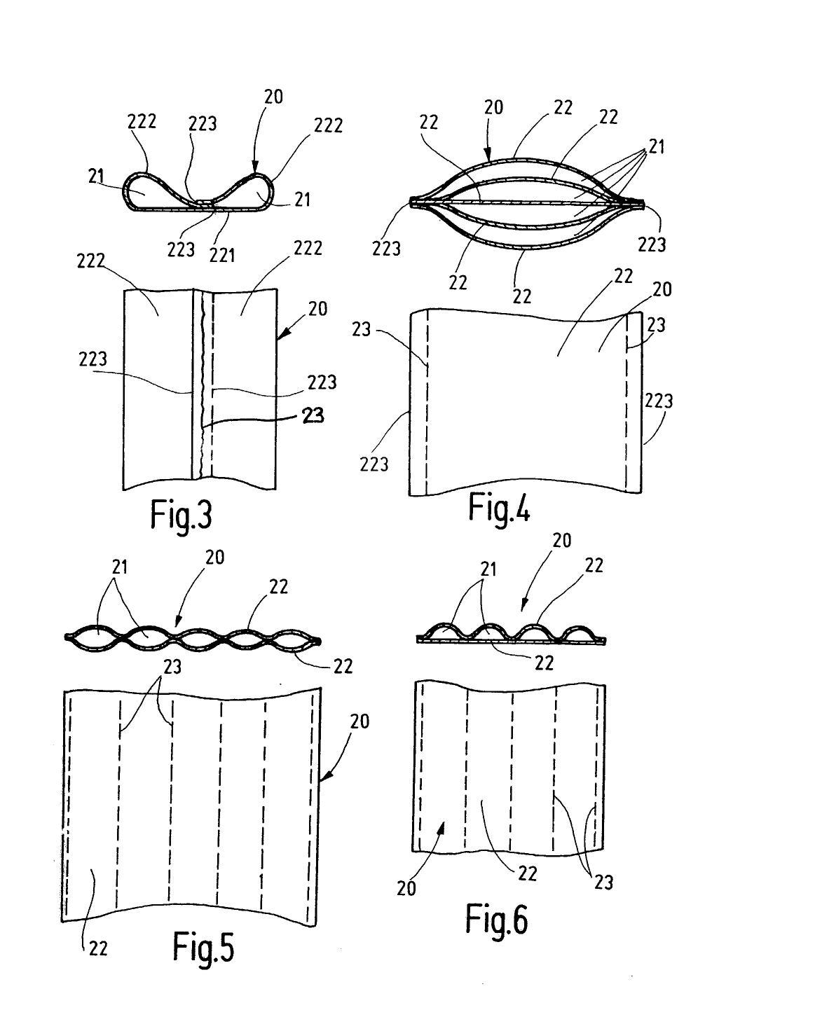

To insulate conductors 151 electrically from each other and from metal tube 16, an insulating cover 20 is inserted into metal tube 16, and conductors 151 are each drawn through one of two tunnels formed in insulating cover 20 and extending for its entire length (FIG. 2). As FIG. 1 illustrates, insulating cover 20 extends from sealing grommet 17 to limit stop 18, having its particular end faces in contact with these components. In FIG. 2, for the sake of clarity, insulating cover 20 is illustrated with conductors 151 which are enclosed in tunnels 21 pulled part of the way out of metal tube 16. FIG. 3 again illustrates insulating cover 20 which is visible in FIG. 2, in cross-section (above) and partial top view (below). Insulating cover 20 is formed by a long, thin, flexible strip 22 of an electrically insulating material. Long flexible strip 22 has a middle zone 221 extending the entire length of the strip, and two edge zones 222 adjacent thereto, also extending the entire length of the strip. To form described tunnels 21, edge zones 222 are turned up onto middle zone 221 so that one edge zone 222 has its free end arranged on middle zone 221 and the other edge zone 222 has its free end arranged on the free end of the edge zone 222 which is turned up onto middle zone 221. Edge zones 222 are joined with middle zone 221 along a line 23, which extends at a slight distance from longitudinal edges 223 of edge zones 222 and is indicated in FIG. 3 with a dashed line. It is also possible for the two edge zones 222 to be folded over onto middle zone 221 such that their free ends are arranged on middle zone 221 with their longitudinal edges 223 butting together. In this case, a linear connection 23 is made between each edge zone 222 and middle zone 221, close to the abutting longitudinal edges 223 of edge zones 222. For strip 22, a layer of a textile fabric such as glass silk may be used, which is resistant to high temperatures and has good insulating properties. Such a layer of textile fabric is highly flexible, so that even flattening of metal tube 16, as illustrated in FIG. 2, as well as extremely small bending of metal tube 16, is possible. Because of the possibility of flattening and bending metal tube 16, installation space available for detector 10 may be used optimally. When strip 22 is in the form of a flexible textile fabric, linear connection 23 between edge zones 222 and middle zones 221 is produced by sewing turned-up edge zones 222 onto middle zone 221.

If detector 10 is configured as a compact lambda probe, a hookup connection 14 may be necessary in which an electrical connection may be established between coupler 13 in detector housing 10 and the connecting plug using four or five stranded wires 15, depending on the configuration of the lambda probe. For these cases, insulating cover 20 is merely modified so that it is able to contain the four or five stripped electrical conductors 151. The remainder of the configuration of hookup connection 14 remains unchanged. FIGS. 4 and 6 illustrate two example embodiments in which insulating cover 20 is implemented with four parallel tunnels 21.

In the exemplary embodiment illustrated in FIG. 4, five long, thin, flexible strips 22 of an electrically insulating material are placed one on top of the other and are joined together along a line 23 extending near their longitudinal edges 223. Subsequent strip 22 which is placed on top of preceding strip 22 has a greater width than the latter, and strips 22 are placed on top of each other such that their longitudinal edges 223 are flush with each other. In this manner the desired tunnels 21 form between strips 22, the number of tunnels 21 being one less than the number of stacked strips 22. Thus with the four tunnels 21 desired, as in this case, five strips 22 may be processed in the manner described. Flexible layers of textile fabric of a high-temperature-resistant textile fabric such as glass silk may be used as strips 22. The linear connections 23 are implemented with sewn seams.

In the exemplary embodiment illustrated in FIG. 6, to produce the four tunnels 21 in insulating cover 20, two wide strips 22, for example layers of textile fabric, may be placed on top of one another and joined together along a plurality of lines 23 extending at lateral intervals from each other. Linear connections 23 are again produced by appropriately sewing the two strips 22. To obtain four parallel tunnels 21, a total of five seams or linear connections 23 are necessary. The sections of strips 22 remaining between linear connections 23 are arranged loosely one on top of the other, and may be expanded into a tunnel 21 as each conductor 151 is inserted.

If tunnels 21 with greater cross-sectional clearance are needed, then one strip 22 may be sewn onto the other strip 22—as illustrated in FIG. 6—such that the width of the sections of one strip 22 remaining between linear connections 23 is somewhat greater than the lateral spacing of linear connections 23. As a result, the wave-shaped bulges visible in the cross-sectional view in FIG. 6 form in the strip 22 having the greater width. Together with the other strips 22 which close them, they surround tunnels 21.

The implementation of insulating cover 20 with a total of five tunnels 21, each to receive one conductor 151, as illustrated in FIG. 5, like insulating cover 20 illustrated in FIG. 6, is made from two wide strips 22 of electrically insulating material. Corresponding to the number of five desired tunnels 21, the two strips 22 are joined together along a total of six lines 23 extending parallel to each other at the same lateral distance from each other along the entire length of the strip.

What is claimed is:

1. An insulating cover for at least two electrical conductors, comprising:
at least two adjacent parallel tunnels configured to receive an electrical conductor, the tunnels made by shaping at least one long, thin, flexible strip of electrically insulating material.

2. The insulating cover according to claim 1, wherein two edge zones of the strip extending to the left and the right of a defined middle zone extending a length of the strip, bounded by longitudinal edges of the strip, are turned up onto the middle zone and are joined to the middle zone along at least one line extending near the longitudinal edges of the strip, such that one of the tunnels forms between each of the edge zones and the middle zone.

3. The insulating cover according to claim 1, wherein two strips are arranged one on top of the other and joined with each other along two parallel lines to form linear connections at a lateral interval along an entire length of the strips, such that the tunnels are formed between sections of the two strips arranged loosely one on top of the other between the linear connections.

4. The insulating cover according to claim 3, wherein a number of linear connections is one more than a number of the tunnels.

5. The insulating cover according to claim 3, wherein a width of the sections of at least one of the two strips arranged between the linear connections is greater than a lateral spacing of the linear connections.

6. The insulating cover according to claim 1, wherein at least three strips are arranged one on top of the other and are joined together along an entire length of the strips along two lines extending a small distance from longitudinal edges of the strips.

7. The insulating cover according to claim 6, wherein a subsequent strip arranged on top of a preceding strip is wider than the preceding strip, and the strips are arranged one on top of another such that longitudinal edges of the strips are flush with each other.

8. The insulating cover according to claim 1, wherein the electrically insulating material includes high temperature-resistant material.

9. The insulating cover according to claim 3, wherein each strip includes a layer of textile fabric and the linear connections are produced by sewing.

10. The insulating cover according to claim 9, wherein the textile fabric includes glass silk.

11. The insulating cover according to claim 1, wherein the cover is configured as a hookup connection for a detector having at least two bare conductors extending in a metal tube, the insulating cover inserted into the metal tube and the conductors drawn through one of the tunnels.

12. The insulating cover according to claim 11, wherein the detector is configured to determine one of an oxygen content and a temperature in an exhaust gas of an internal combustion engine.

13. A hookup connection for a detector, comprising:
a metal tube configured to be secured at one end in a detector housing;
at least two electrical conductors extending in the metal tube that are insulated from each other and from the metal tube; and
an insulating cover extending in the metal tube including at least two adjacent parallel tunnels enclosing each of the electrical conductors along their entire length, the tunnels made by shaping at least one long, thin, flexible strip of electrically insulating material.

14. The hookup connection according to claim 13, wherein the detector is configured to determine one of an oxygen content and a temperature in an exhaust gas of an internal combustion engine.

15. The hookup connection according to claim 13, wherein each electrical conductor includes a solid wire.

16. The hookup connection according to claim 13, wherein each electrical conductor includes a stranded wire having an insulating jacket of material with little heat resistance, having a section stripped of insulation.

17. A detector, comprising:
a sensor element located in a detector housing and including at least two electrical conductors emerging from the detector housing configured to connect the sensor element, two conductors arranged in a metal tube, one end of which is secured in the detector housing and are electrically insulated from each other and from the metal tube; and
an insulating cover located in the metal tube, having at least two adjacent parallel tunnels enclosing each of the electrical conductors along an entire length the tunnels made by shaping at least one long, thin, flexible strip of electrically insulating material.

18. The detector according to claim 17, wherein the detector is configured to determine one of an oxygen content and a temperature in an exhaust gas of an internal combustion engine.

19. The detector according to claim 17, wherein each electrical conductor includes a solid wire.

20. The detector according to claim 17, wherein each electrical conductor includes a stranded wire having an insulating jacket of material with little heat resistance having a section stripped of insulation.
